(19) United States
(12) Patent Application Publication
(10) Pub. No.: US 2013/0082833 A1
(43) Pub. Date: Apr. 4, 2013

(54) SYSTEM AND METHOD FOR MONITORING HEALTH OF AIRFOILS

(71) Applicants: Aninda Bhattacharya, Bangalore (IN); Vivek Venugopal Badami, Schenectady, NY (US); Rahul Srinivas Prabhu, Bangalore (IN); Ajay Kumar Behera, Bangalore (IN); Venkatesh Rajagopalan, Bangalore (IN)

(72) Inventors: Aninda Bhattacharya, Bangalore (IN); Vivek Venugopal Badami, Schenectady, NY (US); Rahul Srinivas Prabhu, Bangalore (IN); Ajay Kumar Behera, Bangalore (IN); Venkatesh Rajagopalan, Bangalore (IN)

(73) Assignee: GENERAL ELECTRIC COMPANY, SCHENECTADY, NY (US)

(21) Appl. No.: 13/250,027

(22) Filed: Sep. 30, 2011

(51) Int. Cl. G06N 5/04; G08B 23/00

(52) U.S. Cl. 340/517; 706/52

(57) ABSTRACT

A method for monitoring health of airfoils is disclosed. The method comprises generating at least one feature alarm for a blade by fusing a plurality of features corresponding to the blade utilizing a fuzzy inference method. The fuzzy inference method comprises generating a plurality of intermediate values by fusing one or more combinations of the plurality of features utilizing a fuzzy logic method, and fusing the plurality of intermediate values utilizing a second level fuzzy logic method, wherein the at least one feature alarm is representative of the health of the blade.

### BACKGROUND

Embodiments of the disclosure relate generally to systems and methods for monitoring health of rotor blades or airfoils.

Rotor blades or airfoils play a role in many devices with several examples, such as, axial compressors, turbines, engines and turbo-machines. For example, an axial compressor typically has a series of stages with each stage comprising a row of rotor blades followed by a row of static blades. Accordingly, each stage generally comprises a pair of rotor blades and static blades. As an illustrative axial compressor example, the rotor blades increase the kinetic energy of a fluid that enters the axial compressor through an inlet. Furthermore, the static blades generally convert the increased kinetic energy of the fluid into static pressure through diffusion. Accordingly, the rotor blades and static blades play an important role to increase the pressure of the fluid.

The rotor blades and the static blades (hereinafter “blades”) are used in wide and varied applications of the axial compressors that include the blades. Axial compressors, for example, may be used in a number of applications, such as, land based gas turbines, jet engines, high speed ship engines, small scale power stations, and the like. In addition, the axial compressors may be used in varied applications, such as, large volume air separation plants, blast furnace air, fluid catalytic cracking air, propane dehydrogenation, and the like.

The blades operate for long hours under extreme and varied operating conditions, such as, high speed, pressure and temperature that affect the health of the blades. In addition to the extreme and varied operating conditions, certain other factors lead to fatigue and stress of the blades. This may include factors, such as, inertial forces including centrifugal force, pressure, resonant frequencies of the blades, vibrations in the blades, vibratory stresses, temperature stresses, reseating of the blades, and load of the gas or other fluids. A prolonged increase in stress and fatigue over a period of time leads to defects and cracks in the blades. Furthermore, one or more of the cracks may widen or otherwise worsen with time to result in a liberation of a blade or a portion of the blade. The liberation of the blade may be hazardous for the device resulting in the failure of the device and significant cost. In addition, it may create an unsafe environment for people near the device and result in serious injuries.

Accordingly, it is highly desirable to develop a system and method that detects the health of rotor blades in real time. More particularly, it is desirable to develop a system and method that predicts cracks or fractures.

### BRIEF DESCRIPTION

Briefly in accordance with one aspect of the technique, a method for monitoring the health of one or more blades is presented. The method includes generating at least one feature alarm for a blade by fusing a plurality of features corresponding to the blade utilizing a fuzzy inference method. The fuzzy inference method includes generating a plurality of intermediate values by fusing one or more combinations of the plurality of features utilizing a fuzzy logic method, and fusing the plurality of intermediate values utilizing a second level fuzzy logic method, wherein the at least one feature alarm is representative of the health of the blade.

In accordance with an aspect of the present technique, a method for monitoring the health of a rotating blade is presented. The method includes generating a blade alarm for a blade by fusing a plurality of feature alarms corresponding to the blade utilizing a fuzzy inference method, wherein the fuzzy inference method includes generating a plurality of intermediate values by fusing one or more combinations of the plurality of features utilizing a fuzzy logic method, and iteratively fusing the plurality of intermediate values utilizing a second level fuzzy logic method, wherein the feature alarms comprise a static deflection alarm and a frequency detuning alarm.

In accordance with one aspect, a system is presented. The system, includes a processing subsystem comprising an alarm generation module that generates at least one feature alarm for a blade by fusing a plurality of features corresponding to the blade utilizing a fuzzy inference method, wherein the fuzzy inference method comprises, generating a plurality of intermediate values by fusing one or more combinations of the plurality of features utilizing a fuzzy logic method, and iteratively fusing the plurality of intermediate values utilizing a second level fuzzy logic method, wherein the at least one feature alarm is representative of the health of the blade.

In accordance with still another aspect, a system is presented. The system includes an alarm generation module, wherein the alarm generation module includes a feature alarm generator that generates a plurality of feature alarms corresponding to a plurality of blades by fusing a plurality of features corresponding to the plurality of blades utilizing a fuzzy inference method, wherein the fuzzy inference method includes generating a plurality of intermediate values by fusing one or more combinations of the plurality of features utilizing a fuzzy logic method, and fusing one or more combinations of the plurality of intermediate values utilizing a second level fuzzy logic method, and a blade alarm generator that generates a plurality of blade alarms corresponding to the plurality of blades by fusing the plurality of blade alarms utilizing a fuzzy inference method, wherein the at least one feature alarm is representative of the health of the blade.

In accordance with still another aspect, a turbine engine system is presented. The turbine system includes a plurality of sensing devices to generate signals representative of times of arrival corresponding to a plurality of blades, a processing subsystem that generates a plurality of features based upon the times of arrival corresponding to the plurality of blades, a processing subsystem comprising an alarm generation module that fuses the plurality of features at multiple levels utilizing a fuzzy inference method to generate at least one alarm, wherein the at least one alarm is representative of the health of the plurality of blades.

In accordance with another aspect, a non-transitory computer readable medium for a blade health monitoring system encoded with a program to instruct a ne or more processors is presented. The program instructs to the one or more processors to fuse a plurality of features for a plurality of blades at multiple levels utilizing a fuzzy inference method to generate at least one alarm, wherein the at least one alarm is representative of the health of the plurality of blades.

### DRAWINGS

These and other features, aspects, and advantages of the present system will become better understood when the following detailed description is read with reference to the accompanying drawings in which like characters represent like parts throughout the drawings, wherein:

FIG. 1 is an exemplary diagrammatic illustration of a blade health monitoring system, in accordance with an embodiment of the present system;

FIG. 2 is an exemplary block diagram representing an exemplary hierarchical structure of an alarm generation module in FIG. 1, in accordance with an embodiment of the present system;

FIG. 3 is an exemplary flow diagram of a static deflection fuzzy inference method referred to in FIG. 2, in accordance with an embodiment of the present techniques;

FIG. 4 is an exemplary flow diagram that describes a first level fuzzy logic for determination of intermediate values, in accordance with an embodiment of the present techniques;

FIG. 5 is shows exemplary trapezoidal membership functions that are used for determination of a strength of a red category data, in accordance with an embodiment of the present techniques;

FIG. 6 is an exemplary flow diagram of a frequency detuning fuzzy inference method, in accordance with an embodiment of the present techniques;

FIG. 7 is an exemplary flow diagram that describes a second level fuzzy logic to generate a static deflection alarm, in accordance with an embodiment of the present techniques;

FIG. 8 is an exemplary flow diagram that describes a method for generation of blade alarms generated by the blade alarm generator in FIG. 2, in accordance with an embodiment of the present techniques; and

FIG. 9 is a flowchart representing an exemplary method for determining features of one or more blades, in accordance with an embodiment of the present techniques.

### DETAILED DESCRIPTION

As discussed in detail herein, embodiments of the present systems and techniques evaluate the health of one or more rotating blades or airfoils. Hereinafter, the terms “airfoils,” “rotating blades” and “blades” will be used interchangeably. The systems and techniques generate alarms based upon features corresponding to the blades. Particularly, the systems and methods generate the alarms by fusing the features at multiple levels using a fuzzy inference method. The features, for example, include static deflection, dynamic deflection, clearance, frequency detuning, and the like. As used herein, the term “static deflection” may be used to refer to a deflection in the position of a blade from the expected or original position of the blade. Also, as used herein, the term, “dynamic deflection” may be used to refer to an amplitude of vibration of a blade over the mean position of the blade. Furthermore, as used herein, the term “clearance” may be used to refer to a distance between the tip of a sensor and the tip of blade. Furthermore, as used herein, the term frequency detuning” may be used to refer to a deviation in the resonance frequencies of a blade.

The alarms, for example, may include an alert alarm, a watch alarm, a healthy alarm, and the like. As used herein, the term “alert alarm” is used to refer to an alarm that is generated when there is a severe blade health contingency. Also, the term “watch alarm” is used herein to refer to an alarm that is generated when there are certain defects that may propagate resulting in larger defects. As used herein, the term “healthy alarm,” is used to refer to an alarm that is generated when there are negligible health contingencies. For ease of understanding, the terms “alert alarm” and “Red alarm” shall be used interchangeably. Also, the terms “watch alarm” and “Yellow alarm” shall be used interchangeably. Similarly, the terms “healthy alarm” and “Green Alarm” shall be used interchangeably.

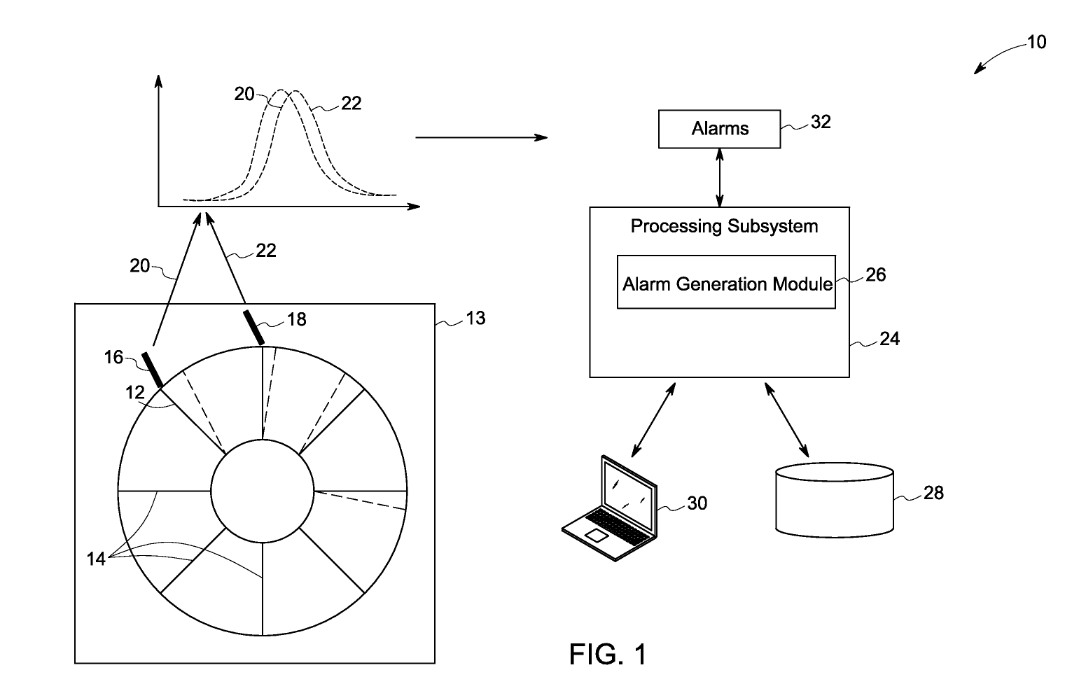

FIG. 1 is an exemplary diagrammatic illustration of a blade health monitoring system 10, in accordance with an embodiment of the present system. The system 10 generates one or more alarms 32 that depict the health of a plurality of blades 12, 14, a device 13 that includes the blades 12, 14, and multiple stages of blades (not shown) in the device 13. The system 10 determines a plurality of features corresponding to the blades 12, 14. Furthermore, the system 10 generates the alarms by fusing the features utilizing a fuzzy inference method.

As shown in the presently contemplated configuration, the system 10 includes the blades 12, 14 in the device 13 and one or more sensors 16, 18. The device 13, for example, may be a gas turbine, a compressor including an axial compressor, a turbine engine, and the like. In one embodiment, the device 13 may have multiple stages of blades (not shown). It is noted that the presently illustrated configuration shows a single stage of the blades 12, 14 in the device 13, the system 10 may monitor and generate alarms to depict the health of multiple stages of blades in the device 13.

The sensors 16, 18 generate timing signals, such as, times of arrival (TOA) signals 20, 22 by sensing arrivals of the blades 12, 14 at a reference point in the device 13. In one embodiment, the sensors 16, 18 generate the TOA signals 20, 22 by sensing an arrival of each blade 12, 14 in the device 13. The TOA signals 20, 22 are representative of actual times of arrival (TOA) of the blades 12, 14 at the reference point. The reference point, for example, may be proximate, such as, underneath the sensors 16, 18 or adjacent to the sensors 16, 18. In one embodiment, the sensors 16, 18 may sense an arrival of the leading edge of one or more of the blades 12,14 to generate the TOA signals 20, 22. In another embodiment, the sensors 16, 18 may sense an arrival of the trailing edge of one or more of the blades 12, 14 to generate the signals 20, 22. In still another embodiment, the sensor 16 may sense an arrival of the leading edge of one or more of the blades 12 to generate the TOA signals 20, and the sensor 18 may sense an arrival of the trailing edge of one or more of the blades 14 to generate the TOA signals 22, or vice versa. The sensors 16, 18, for example, may be mounted adjacent to one or more of the blades 12 on a stationary object in a position such that an arrival of one or more of the blades 12 may be sensed efficiently. In one embodiment, at least one of the sensors 16, 18 is mounted on a casing (not shown) of the one or more blades 12. By way of a non-limiting example, the sensors 16, 18 may be magnetic sensors, capacitive sensors, eddy current sensors, or the like.

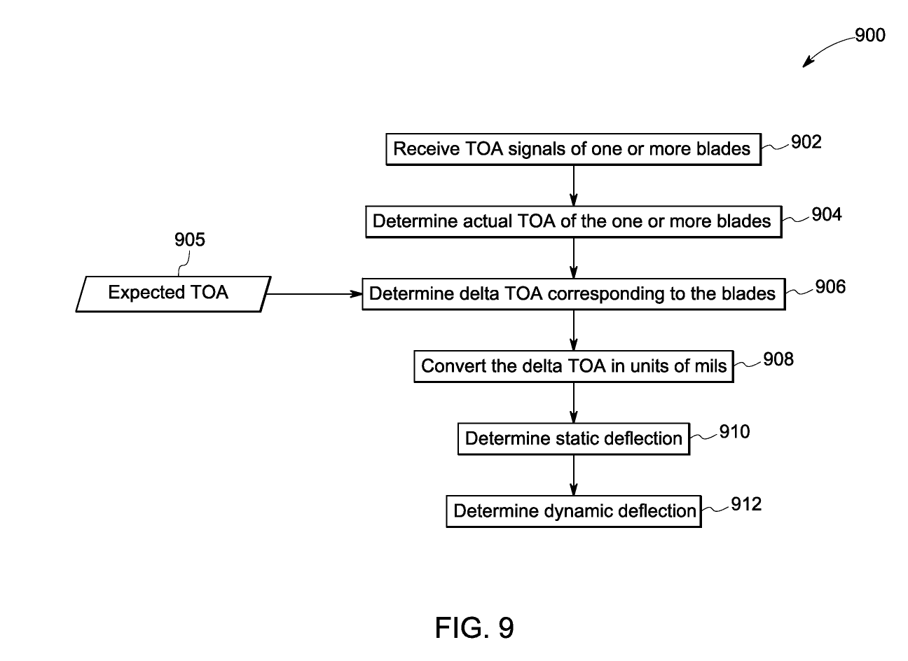

As illustrated in the presently contemplated configuration, the TOA signals 20 22 are transmitted to a processing subsystem 24. The processing subsystem 24 receives the TOA signals 20, 22 from the sensing devices 16, 18. The processing subsystem 24 may receive the TOA signals and communicate with the sensing devices 16, 18 via. a wireless connection or a wired connection. Furthermore, the processing subsystem 24 determines a plurality of features corresponding to the blades 12, 14 based upon the TOA signals 20, 22. In one embodiment, the processing subsystem 24 determines a plurality of features corresponding to each blade 12, 14 in the device 13. The features, for example, include static deflection, dynamic deflection, resonance detuning, clearance, or the like. The determination of the static deflection and/or dynamic deflection is explained in greater detail with reference to FIG. 9.

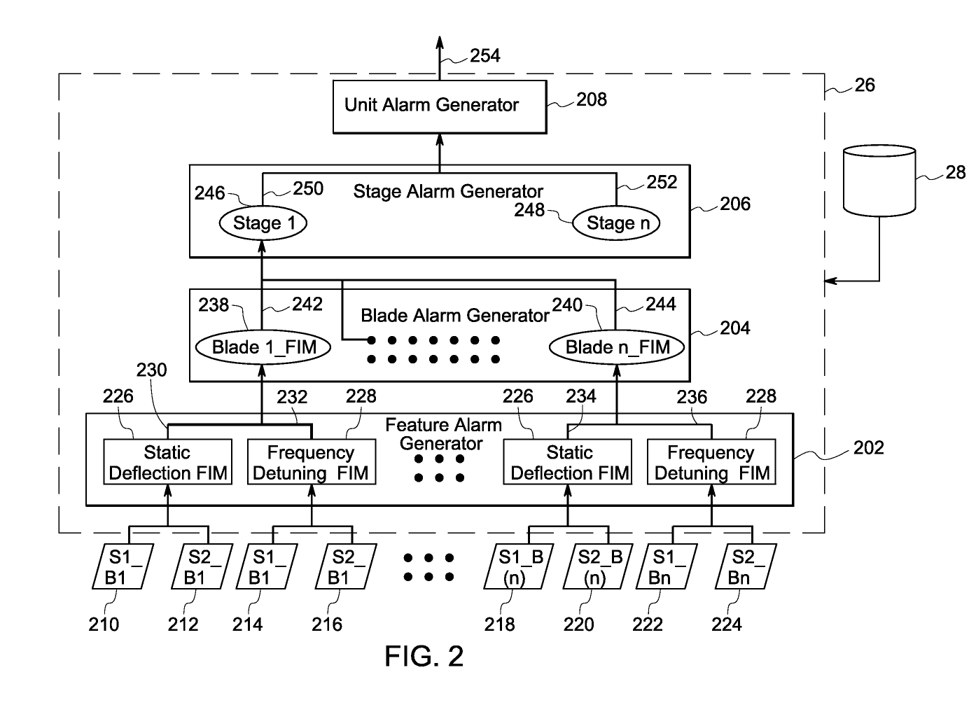

In one embodiment, the processing subsystem 24 includes an alarm generation module 26 that generates the alarms. As previously noted, the alarms are representative of the health of the blades 12, 14, each stage of blades (not shown) in the device 13 and the device 13. The alarm generation module 26 generates the alarms by fusing the features corresponding to the blades 12, 14. In one example the alarm generation module 26 is an algorithm within the processing subsystem 24. The alarm generation module 26 fuses the features by utilizing a fuzzy inference method. The generation of the alarms is explained in greater details with reference to FIGS. 2-8. Hereinafter, the terms “stage of blades” and “stage” shall be used interchangeably. The system 10 further includes a data repository 28 that stores the alarms and any intermediate results or data. Furthermore, the system 10 includes a device 30 that shows the alarms or the intermediate results or data. The device 30 also allows for user intervention such as modifying thresholds and trigger limits.

Referring now to FIG. 2, an exemplary block diagram representing an exemplary hierarchical structure of the alarm generation module 26 in FIG. 1, in accordance with an embodiment of the present system, is depicted. As shown in FIG. 2, the alarm generation module 26 in this example includes a feature alarm generator 202, a blade alarm generator 204, a stage alarm generator 206 and a unit alarm generator 208. The feature alarm generator 202, blade alarm generator 204, stage alarm generator 206 and unit alarm generator 208 generate alarms that are representative of the health of the blades 12, 14 in the device 13, stages of blades in the device 13 and the device 13.

Particularly, the feature alarm generator 202 generates feature alarms corresponding to the blades, such as, the blades 12, 14 in the device 13. The feature alarm generator 202 generates the feature alarms by fusing features corresponding to the blades using a fuzzy inference method. As previously noted, the features, for example, include static deflection, dynamic deflection, resonance detuning, clearance, or the like. As used herein, the term “feature alarm” is used to refer to an alarm that is generated when at least one feature of a blade shows a defect, potential defect indications in the blade. For example, the feature alarm may include a static deflection alarm, a dynamic deflection alarm, a clearance alarm and a frequency detuning alarm. As used herein, the term “static deflection alarm” is used to refer to an alarm that is generated when the static deflection of a blade shows a defect in the blade. Similarly, the term “dynamic deflection alarm” is used to refer to an alarm that is generated when the dynamic deflection of a blade shows a defect in the blade. The term “frequency detuning alarm” is used herein to refer to an alarm that is generated when the resonance frequencies of tracked vibration modes of a blade shows a defect in the blade. The term “clearance alarm” is used herein to refer to an alarm that is generated when the distance between the tip of a blade and the tip of a sensor undergoes a change indicating a defect in the blade.

In the presently contemplated configuration, the feature alarm generator 202 generates the feature alarms by fusing features 210, 212, 214, 216, 218, 220, 222, 224. The reference numeral 210 is representative of static deflection data of a blade B1, in a stage SG1 that is determined based upon TOA signals generated by the sensing device 16. Also, reference numeral 212 is representative of static deflection data of the blade B1 that is determined based upon the TOA signals generated by the sensing device 18. Furthermore, reference numeral 214 is representative of frequency detuning data of the blade B1 that is determined based upon the TOA signals generated by the sensing device 16. Similarly, reference numeral 216 is representative of frequency detuning data of the blade B1 that is determined based upon the TOA signals generated by the sensing device 18. For ease of understanding the following Table 1 shows reference numerals that are mapped to features 210, 212, 214, 216, 218, 220, 224 of the blades B1, B(N), sensing devices 16, 18, and the stage of the blades B1, B(N).

TABLE 1

| | | | Stage | Sensor |
|---|---|---|---|---|
| Reference | | | Of | Reference |
| Numeral | Type of Data | Blade | blades | Numeral |
| 210 | Static | B1 | SG1 | 16 |
| | deflection data | | | |
| 212 | Static | B1 | SG1 | 18 |
| | deflection data | | | |
| 214 | Frequency | B1 | SG1 | 16 |
| | detuning data | | | |
| 216 | Frequency | B1 | SG1 | 18 |
| | detuning data | | | |
| 218 | Static | B(N) | SG1 | 16 |
| | deflection data | | | |
| 220 | Static | B(N) | SG1 | 18 |
| | deflection data | | | |
| 222 | Frequency | B(N) | SG1 | 16 |
| | detuning data | | | |
| 224 | Frequency | B(N) | SG1 | 18 |
| | detuning data | | | |

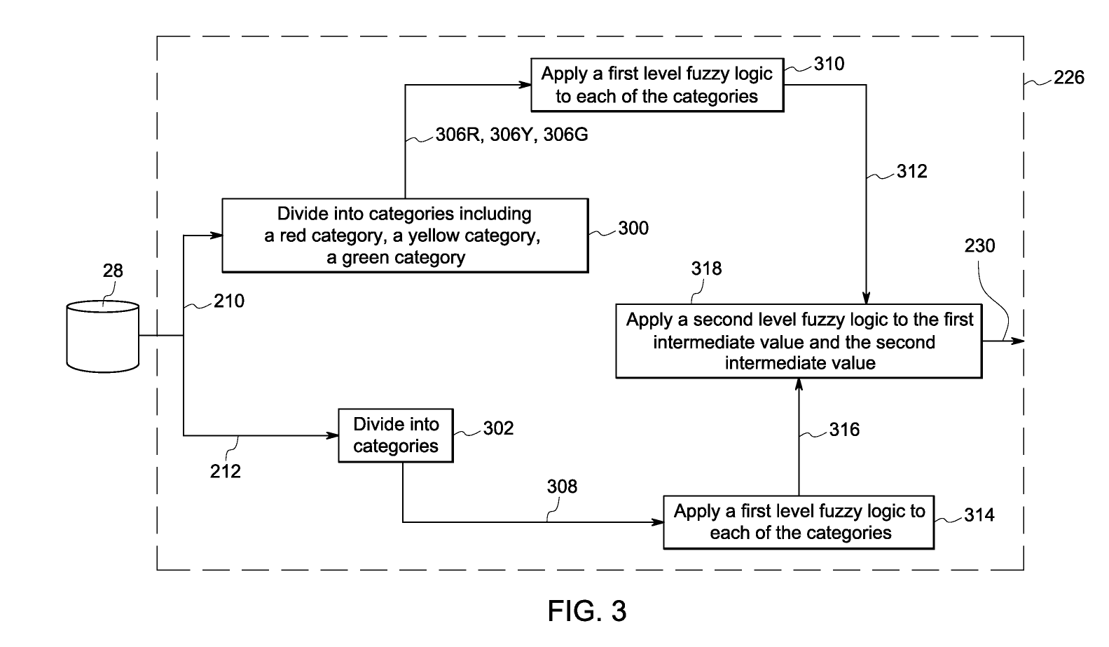

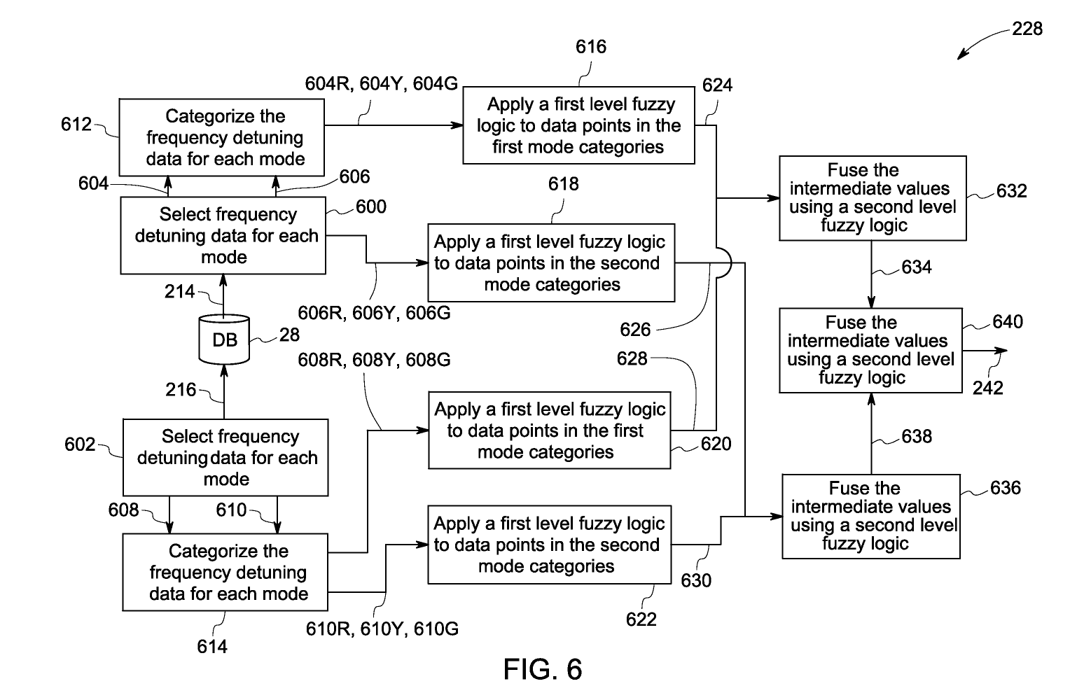

In the presently contemplated configuration, the feature alarm generator 202 receives the static deflection data 210, 212, 220, 222 and the frequency detuning data 214, 216, 222, 224 of the blades B1 and B(N) in the stage SG1. The static deflection data 210, 212 are fused utilizing a static deflection fuzzy inference method (FIM) 226 to generate a static deflection alarm 230 corresponding to the blade B1. The static deflection fuzzy inference method 226 is explained in greater detail with reference to FIGS. 3-5. Similarly, the frequency detuning data 214, 216 are fused using a frequency detuning fuzzy inference method 228. The fusion of the frequency detuning data 214, 216 generates a frequency detuning alarm 232 corresponding to the blade B1. The static deflection data 218, 220 are fused using the static deflection FIM 226 to generate a static deflection alarm 234 corresponding to the blade B(N). Furthermore, the frequency detuning data 222, 224 are fused using the frequency detuning FIM 228 to generate a frequency detuning alarm 236 corresponding to the blade B(N). The frequency detuning FIM 228 is explained in greater detail with reference to FIG. 6. Table 2 shows the blades B1, B(N) mapped to the stage of blades B1, B(N), sensing devices 16, 18 and data fused to generate the alarms 230, 232, 234, 236.

TABLE 2

| | | Sensing Device | | |
|---|---|---|---|---|
| | | Reference | Data | |
| Blade | Stage | Numeral | fused | Type of alarm |
| B1 | SG1 | 16 | Static | Static deflection |
| | | | Deflection | alarm corresponding |
| | | | 210 | to blade B1 230 |
| | | 18 | Static | |
| | | | Deflection | |
| | | | 212 | |
| B1 | SG1 | 16 | Frequency | Frequency detuning |
| | | | Detuning | alarm corresponding |
| | | | 214 | to blade B1 232 |
| | | 18 | Frequency | |
| | | | Detuning | |
| | | | 216 | |
| B(N) | SG1 | 16 | Static | Static deflection |
| | | | Deflection | alarm corresponding |
| | | | 218 | to blade B(N) 234 |
| | | 18 | Static | |
| | | | Deflection | |
| | | | 220 | |
| B(N) | SG1 | 16 | Frequency | Frequency detuning |
| | | | Detuning | alarm corresponding |
| | | | 222 | to blade B(N) 236 |
| | | 18 | Frequency | |
| | | | Detuning | |
| | | | 224 | |

It is noted that while for ease of understanding, in the presently contemplated, the static deflection alarms 230, 234 and frequency detuning alarms 232, 236 are shown as being fused, however, the alarm generation module 226 may fuse other features including clearance, dynamic deflection, or the like. The static deflection alarms 230, 234 and the frequency detuning alarms 232, 236, clearance alarm and dynamic deflection alarms, for example, may be an alert alarm, a watch alarm or a healthy alarm. As used herein, the term “alert alarm” is used to refer to an alarm that is generated when there is a severe health contingency. Also, the term “watch alarm” is used herein to refer to an alarm that is generated when there are certain defects that may propagate resulting in larger defects at some later point. As used herein, the term “healthy alarm,” is used to refer to an alarm that is generated when there are negligible health contingencies. For ease of understanding, the terms “alert alarm” and “Red alarm” shall be used interchangeably. Also, the terms “watch alarm” and “Yellow alarm” shall be used interchangeably. Similarly, the terms “healthy alarm” and “Green Alarm” shall be used interchangeably.

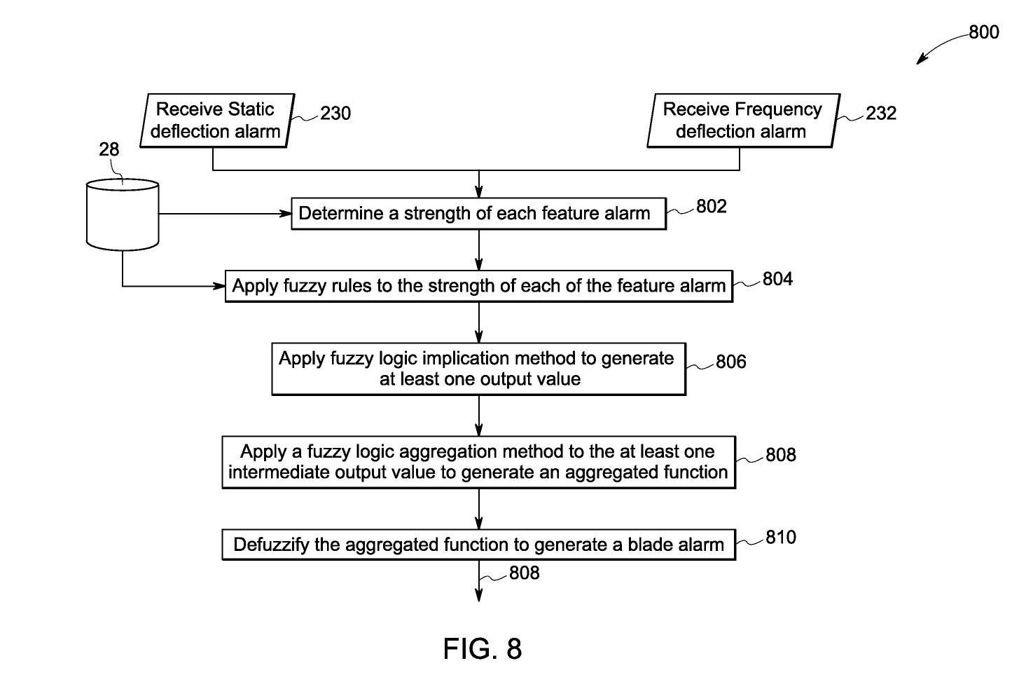

Furthermore, as previously noted, the alarm generation module 26 includes the blade alarm generator 204. The blade alarm generator 204 generates blade alarms corresponding to the blades, such as, the blades 12, 14 in the device 13. As used herein, the term “blade alarm” may be used to refer to an alarm that is generated by fusing feature alarms corresponding to a blade utilizing a fuzzy inference method. In the presently contemplated configuration, the blade alarm generator 204 receives the feature alarms 230, 232, 234, 236 from the feature alarm generator 202. As shown in FIG. 2, reference numeral 238 is representative of the step of generation of a blade alarm 242 corresponding to the blade B1. Additionally, reference numeral 240 is representative of the step of generation of a blade alarm 244 corresponding to the blade B(N). At step 238, the static deflection alarm 230 and the frequency detuning alarm 232 are fused to generate the blade alarm 242 corresponding to the blade B1. Similarly, the static deflection alarm 234 and the frequency detuning alarm 236 may be fused to generate a blade alarm 244 corresponding to the blade B(N). The blade alarms 242, 244 may be generated by using a fuzzy inference method. The generation of the blade alarms 242, 244 is explained in greater detail with reference to FIG. 8. The blade alarms 242, 244, for example, may be the red alarm, the yellow alarm and the green alarm. It may be noted that in the presently contemplated configuration, the blade alarms 242, 244 corresponding to the blades B1 and B(N) in stage SG1, respectively have been shown. However, blade alarms may be generated for each blade in each stage of blades in the device 13.

As previously noted, the alarm generation module 26 includes the stage alarm generator 206 that generates a stage alarm corresponding to at least one stage of blades in the device 13. As used herein, the term “stage alarm” may be used to refer to an alarm corresponding to a stage of blades in a device that shows a defect in a stage of device. The stage alarm generator 206 generates a stage alarm by selecting a blade alarm from blade alarms corresponding to blades in respective stage of blades. For example, if a stage of blades includes ten blades, then the stage alarm generator 206 generates a stage alarm by selecting a blade alarm from the blade alarms corresponding to two or more of the ten blades. In one embodiment, the stage alarm generator 206 generates a stage alarm corresponding to a stage SG1 by selecting the most severe blade alarm from blade alarms corresponding to blades in the stage SG1. For example, if a stage of blades SG1 includes three blades, and blade alarms corresponding to the three blades are red, yellow and green, respectively, then the stage alarm generator 206 selects red alarm as a stage alarm corresponding to the stage SG1.

In the presently contemplated configuration, at step 246, the stage alarm generator 206 receives the blade alarms 242, 244. As previously noted, the blade alarms 242, 244 correspond to the blades B1, B(N) in the stage SG1 in the device 13. At the step 246, the stage alarm generator 206 generates a stage alarm 250 corresponding to the stage SG1 by selecting the most severe alarm of the blade alarms 242, 244. For example, if the blade alarm 242 is a red alarm, and the blade alarm 244 is a yellow alarm, then the stage alarm 250 corresponding to the stage SG1 is a red alarm. Similarly, if the blade alarm 242 is a yellow alarm, and the blade alarm 244 is a green alarm, then the stage alarm 250 corresponding to the stage SG1 is a yellow alarm. Similarly, the stage alarm generator 206 may generate stage alarms corresponding to each stage of blades in the device 13. In the presently contemplated configuration, at step 248, a stage alarm 252 is generated corresponding to a stage S(N) in the device 13.

Furthermore, the alarm generation module 26 includes the unit alarm generator 208. The unit alarm generator 208 generates a device alarm 254 corresponding to the device 13. As used herein, the term “device alarm” may be used to refer to an alarm that shows a defect or potential defect in a device. The device alarm, for example, may be generated based upon the stage alarms 250, 252. Particularly, the unit alarm generator 208 generates the unit alarm 254 by selecting the most severe alarm of the stage alarms 250, 252. For example, if any one of the stage alarms 250, 252 is a red alarm, then the device alarm 254 will be a red alarm. Similarly, if any one of the stage alarms 250, 252 is a yellow alarm, and there are no red alarms, then the unit alarm 254 will be a yellow alarm.

FIG. 3 is an exemplary flow diagram of the static deflection fuzzy inference method 226 referred to in FIG. 2, in accordance with an embodiment of the present method. As noted with reference to FIG. 2, the static deflection fuzzy inference method 226 generates the static deflection alarms 230, 234 corresponding to the blades B1, B(N), respectively. For ease of understanding, FIG. 3 will explain generation of the static deflection alarm 230; however, the fuzzy inference method 226 may be used for generation of static deflection alarms corresponding to any blade including the static deflection alarm 234. The fuzzy inference method 226 extracts static deflection data, such as, the static deflection data 210, 212 (see FIG. 2) from the data repository 28 (see FIG. 1). In one embodiment, the method 226 receives the static deflection data 210, 212 from the processing subsystem 24 (see FIG. 1).

As previously noted, the static deflection data 210 corresponds to the blade B1 that was determined based upon the TOA signals 20 generated by the sensing device 16. The static deflection data 212 corresponds to the blade B1 that was determined based upon the TOA signals 22 generated by the sensing device 18. The static deflection data 210, for example, may be retrieved from the data repository 28. At step 300, the static deflection data 210 is divided into multiple categories. In the presently contemplated configuration, the static deflection data 210 is divided into three categories including a red category 306R, a yellow category 306Y and a green category 306G. It is noted that each of the categories 306R, 306Y, 306G is a set of one of more data points. The static deflection data 210 is divided into the three categories 306R, 306Y, 306G by using at least one determined thresholds. The determined thresholds, for example, may be retrieved from the data repository 28. In one presently contemplated configuration, the determined thresholds include a red threshold and a yellow threshold. In one embodiment, these determined thresholds are determined by using finite element models. Similarly, at step 302, the static deflection data 212 is divided into one or more categories 308. In an exemplary embodiment, the division of the static deflection data 210, 212 into the categories 306R, 306Y, 306G, 308 using the yellow threshold and red threshold are shown in Table 3:

TABLE 3

| Green Category | Yellow Category | Red Category |
|---|---|---|
| Static deflection data | Static deflection data | Static deflection data |
| point < Yellow Threshold | point > Yellow | point > Red threshold |
| | threshold and Static | |
| | deflection data < Red | |
| | Threshold | |

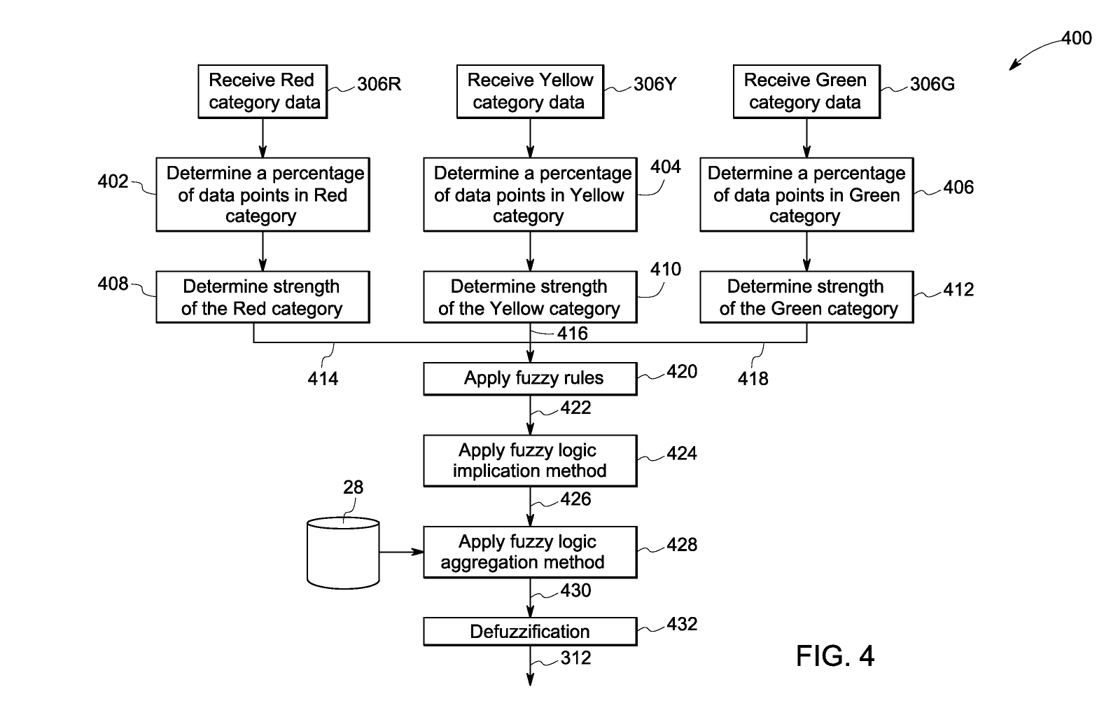

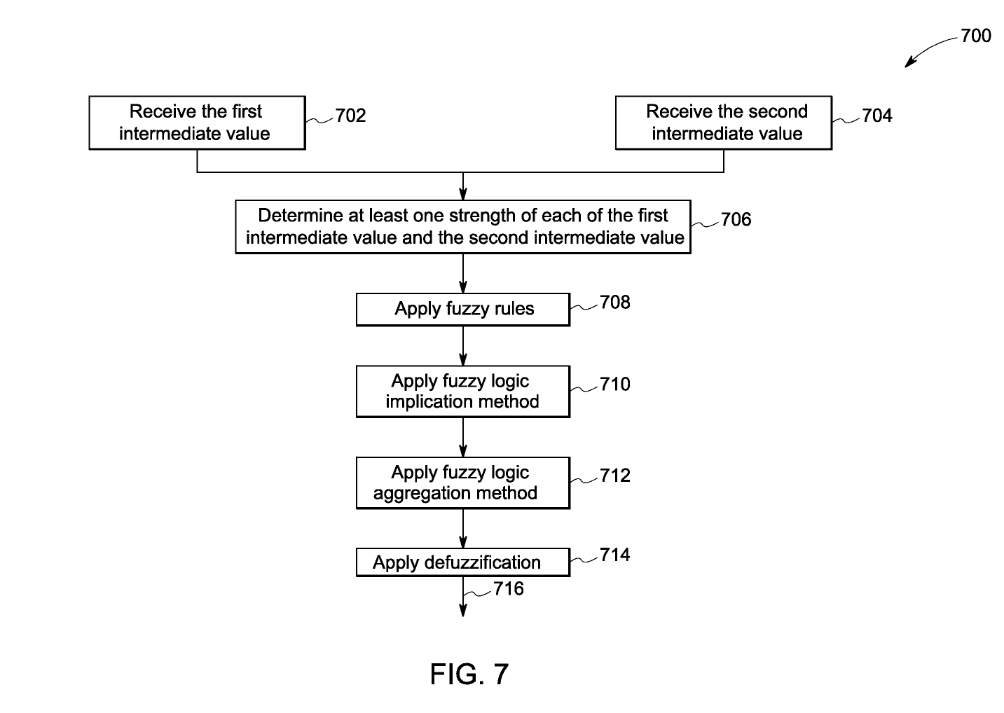

Furthermore, at step 310, a first level fuzzy logic is applied to each of the categories 306R, 306Y, 306G to generate a first intermediate value 312. Similarly, at step 314, a first level fuzzy logic is applied to each of the categories 308 to generate a second intermediate value 316. The application of the first level fuzzy logic to the categories 306R, 306Y, 306Y, 308 is explained in greater detail with reference to FIG. 4. At step 318, a second level fuzzy logic is applied to the first intermediate value 312 and the second intermediate value 316. The application of the fuzzy logic to the first intermediate value 312 and the second intermediate value 316 results in the generation of the static deflection alarm 230. The second level fuzzy logic shall be explained in greater detail with reference to FIG. 7.

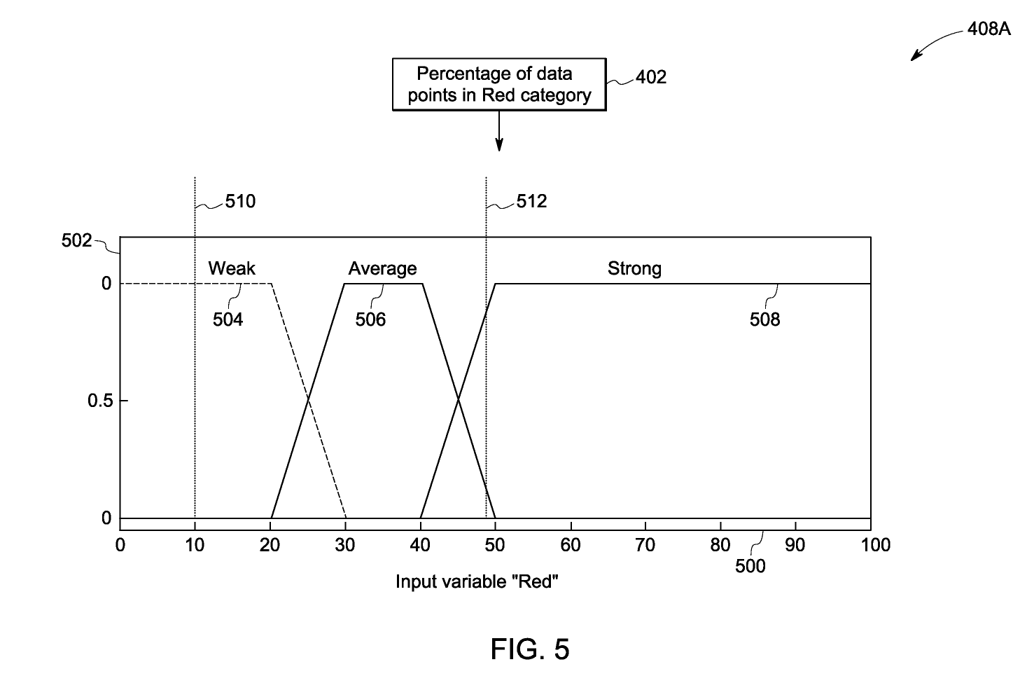

FIG. 4 is an exemplary flow diagram 400 that describes the first level fuzzy logic used in steps 310, 314 for determination of the first intermediate value 312 and the second intermediate value 316, in accordance with an embodiment of the present method. It may be noted that though for ease of understanding, FIG. 4 explains determination of the first intermediate value 312 by applying a first level fuzzy logic to the categories 306R, 306Y, 306G, however, the method 400 may be used to generate the second intermediate value 316, or other intermediate values. As shown in FIG. 4, reference numeral 306R is representative of red category data. Reference numeral 306Y is representative of yellow category and 306G is representative of green category. In one embodiment, the data categories 306R, 306Y, 306G have been formed by categorizing the static deflection data 210 at step 300 in FIG. 3. At step 402, a percentage of data points in the red category is determined. The percentage of data points in the red category 306R is determined based upon the total number of data points in the static deflection data 210. For example, the percentage of data points in the red category 306R may be determined using the following equation:

$$Percent\_data \_pts \_red = \frac{number of data pts in red category}{Number of data pts in static deflection data set}$$

wherein Percent_data_pts_red is a percentage of data points in a red category. Similarly, at step 404, a percentage of data points in the yellow category 306R may be determined, and at step 406, a percentage of data points in the green category 306G may be determined The percentage of data points in the categories 306R, 306Y, 306G, for example, may be determined based upon the total number of data points in the static deflection data 210. At step 408, strength 414 of the red category 306R is determined The strength 414 of the red category 306R, for example, is determined by using at least one membership function for the red category and the percentage of data points in the red category 306R. In alternative embodiments, the strength 414 of the red category 306R, for example, is determined by using at least one membership function for the red category and a total number data points in the red category 306R. The membership function for the red category may be a trapezoidal function, a triangular function, a Gaussian function, a sigmoidal function and the like. The determination of the strength of red category by using a membership function is described in greater detail with reference to FIG. 5.

FIG. 5 shows exemplary trapezoidal membership functions 408A that are used for determination of the strength 414 of the red category 306R (See FIG. 4) is described. The trapezoidal membership functions 408A together may be referred to as a universe of disclosure 408A. Particularly, FIG. 5 describes the step 408 in FIG. 4 in greater detail. It may be noted, that while FIG. 5 shows the universe of disclosure 408A for determination of the strength 414 of the red category 306, other universe of disclosures may be used for determination of strength of a category. An input to the universe of disclosure 408A is the percentage of data points determined at the step 402 in FIG. 4, and the output of the universe of disclosure 408A is the strength 414 of the red category 306R. In certain embodiments, an input to the universe of disclosure 408A may be a number of data points in a category. An input to the universe of disclosure 408A is the percentage of data points. X-axis 500 is representative of percentage of data points in the red category 306R. Y-axis 502 is representative of weight of the percentage of data points shown in the X-axis. As shown in FIG. 5, the universe of disclosure 408A includes three membership functions including a weak membership function 504, an average membership function 506 and a strong membership function 508. The strength 414 of the red category 306R is determined based upon the percentage of data points in the red category 306R. For example, as shown by a vertical line 510, if the percentage of the data points in the red category 306R is ten percent, then the strength 414 of the red category 306R is weak 504. Similarly, as shown by a vertical line 512, if the percentage of data points in the red category 306R is forty eight percent, then the strength 414 of the red category 306R is average 506 with a weight of 0.2. Additionally, the strength 414 of the red category 306R is strong 508 with a weight of 0.8.

Turning back to FIG. 4, at step 410, strength 416 of the yellow category 306Y is determined, and at step 412 strength 418 of the green category 306G is determined The strength 416 of the yellow category 306Y and strength 418 of the green category 306G may be determined by using respective membership functions. The membership functions for the yellow category 306Y and the green category 306G may be a trapezoidal function, a triangular function, a Gaussian function, a sigmoidal function, and the like. In one embodiment, the strengths 416, 418 may be determined by a method similar to the method explained with reference to FIG. 5. In the presently contemplated configuration, the strengths 414, 416, 418 of the red category 306R, yellow category 306Y and green category 306G, respectively may be weak 504, average 506 or strong 508 (see FIG. 5).

At step 420, one or more fuzzy rules may be applied to the strengths 414, 416, 418 of the categories 306R, 306Y, 306G to determine one or more intermediate categories 422. The fuzzy rules, for example, may be applied based upon the strengths 414, 416, 418. Table 4 shows exemplary fuzzy rules.

TABLE 4

| Rule | Green category | Yellow category | Red category | Intermediate |
|---|---|---|---|---|
| Number | strength 414 | strength 416 | strength 418 | category |
| 1 | Weak | Weak | Weak | Not possible |
| 2 | Weak | Weak | Average | Red category |
| 3 | Weak | Weak | Strong | Red category |
| 4 | Weak | Strong | Weak | Yellow |
| | | | | category |

It may be noted that the rules in Table 3 and 4 are shown for descriptive purposes, and should not be restricted to their number and meaning. In certain embodiments, more than one fuzzy rules may applied, when at least one of the categories 306R, 306Y, 306G have multiple strengths 504, 506, 508. For example, if the strength 414 of the red category 306R is average 506 and strong 508 (see FIG. 5), then multiple fuzzy rules are applied. Therefore, each of the multiple fuzzy rules will determine an intermediate category, resulting in the multiple intermediate categories 422. For example, if the strength 414 of the red category 306R is determined as average 506 and strong 508, and the strength 416 of the yellow category 306Y is determined as strong 508, and the strength 418 of the green category 306G is determined as weak 504, then the fuzzy rules shown in Table 5 are applied.

TABLE 5

| Red category | Yellow category | Green category | Intermediate |
|---|---|---|---|
| strength | strength | strength | category |
| Average | Strong | Weak | Average |
| Strong | Strong | Weak | Strong |

At step 424, a fuzzy logic implication method is applied to the intermediate categories 422. The fuzzy logic implication method is applied to the intermediate categories 422 utilizing an output membership function, and an implication operator. The output membership function, for example, may be retrieved from the data repository 28. The implication operator, for example, may be a truncation operator, a minimum operator, a probabilistic operator, a maximum operator, or the like. The application of the fuzzy logic implication method results in at least one output value 426. At step 428, a fuzzy logic aggregation method may be applied to the output values 426 to generate an aggregated function 430. As used herein, the term “fuzzy logic aggregation method” may be used to refer to combining the fuzzy conclusions from multiple rules using superimposition. A particular input to a system often triggers multiple fuzzy rules because of partially overlapping conditions. The conclusions of these rules need to be combined and is termed as aggregation. The fuzzy logic aggregation method may be applied by using an aggregation operator. The aggregation operator, for example, may be an addition operator, a minimum operator, a maximum operator, or the like.

At step 432, the aggregated function 430 may be defuzzified to generate a defuzzified value 312. The output function 430, for example, may be defuzzified by determining a centroid, a bisector, a minimum value, a maximum value, or the like of the output function 430. In the presently contemplated configuration, the defuzzified value is representative of the first intermediate value 312 (see FIG. 3).

FIG. 6 is an exemplary flow diagram of the frequency detuning fuzzy inference method 228 referred to in FIG. 2, in accordance with an embodiment of the present techniques. More particularly, FIG. 6 describes the frequency detuning fuzzy inference method 228 used for generating the frequency detuning alarms 232, 236 corresponding to the blades B1 and BN, respectively. It is noted that while for ease of understanding, the present illustration explains generation of the frequency detuning alarms 232, the frequency detuning fuzzy inference method 228 may be used for generating frequency detuning alarms corresponding to any blade.

As previously noted with reference to FIG. 2, the frequency detuning fuzzy inference method 228 generates the frequency detuning alarm 232 by fusing the frequency detuning data 214, 216. As shown in FIG. 6, at step 600, the frequency detuning data 214 may be retrieved from the data repository 28 for each mode of vibration of each blade. Hereinafter, “mode of vibration” and “mode” shall be used interchangeably. For example, when the device 13 is an axial compressor, each blade in the device 13 may operate at multiple modes of vibration. The multiple modes of vibration, for example, may include a first axial mode and thirteenth excitation order (1A/13E), a first flexural mode and second excitation order (1F/2E), a second torsional mode and fourth excitation order (2T/4E), a first axial mode and seventh excitation order (1A/7E), and the like. At step 600, frequency detuning data for a first mode 604 and a frequency detuning data for a second mode 606 are selected from the frequency detuning data 214. Similarly, at step 602, frequency detuning data from for a first mode 608 and frequency detuning data for a second mode 610 are selected from the frequency detuning data 216. It is noted that while in the presently illustrated configuration, frequency detuning data for two modes 604, 606, 608, 610 are selected; however, frequency detuning data for more than two modes may be selected.

Furthermore, at step 612, each of the frequency detuning data for the first mode 604 and frequency detuning data for the second mode 606 may be divided into multiple categories. The multiple categories, for example, may include a red category (R), a yellow category (Y) and a green category (G). In the presently contemplated configuration, the frequency detuning data for the first mode 604 is divided into three categories 604R, 604Y, 604G. Hereinafter, the term “categories 604R, 604Y, 604G” shall be referred to as “first mode categories.” Additionally at the step 612, the frequency detuning data for the second mode 606 is divided into three categories 606R, 606Y, 606G. Hereinafter, the term “categories 606R, 606Y, 606G” shall be referred to as “second mode categories 606R, 606Y, 606G.” Moreover, at step 614 the frequency detuning data for the first mode 608 is divided into categories 608R, 608Y, 608G. Hereinafter, the term “categories 608R, 608Y, 608G” shall be referred to as “first mode categories 608R, 608Y, 608G.” Additionally at the step 614, the frequency detuning data for the second mode 610 is divided into three categories 610R, 610Y, 610G. Hereinafter, the term “categories 610R, 610Y, 610G” shall be referred to as “second mode categories 610R, 610Y, 610G.” In one embodiment, each of the frequency detuning data for each mode 604, 606, 608, 610 may be divided into multiple categories 604R, 604Y, 604G, 606R, 606Y, 606G, 608R, 608Y, 608G, 610R, 610Y, 610G based upon a red threshold, a yellow threshold, a green threshold, or combinations thereof. The red threshold, yellow threshold and green threshold may be determined by using finite element models. In one embodiments, the multiple categories 604R, 604Y, 604G, 606R, 606Y, 606G, 608R, 608Y, 608G, 610R, 610Y, 610G may be generated using the following Table 6:

TABLE 6

| Green Category | Yellow Category | Red Category |
|---|---|---|
| Frequency detuning data | Frequency detuning | Frequency detuning |
| point in frequency | data point in | data point in |
| detuning data for a | frequency detuning | frequency detuning |
| mode < Yellow Threshold | data for a mode > | data for a mode > Red |
| | Yellow threshold | threshold |
| | and Frequency | |
| | detuning data point | |
| | in frequency | |
| | detuning data for a | |
| | mode < Red | |
| | Threshold | |

At step 616, a first level fuzzy logic is applied to data points in the first mode categories 604R, 604Y, 604G to generate a first mode frequency detuning intermediate value 624. The first level fuzzy logic is explained in greater detail with reference to FIG. 4. Similarly, at step 618 the first level fuzzy logic is applied to data points in the second mode categories 606R, 606Y, 606G to generate a second mode frequency detuning intermediate value 626. Additionally, at step 620, the first level fuzzy logic is applied to data points in the first mode categories 608R, 608Y, 608G to generate a first mode frequency detuning intermediate value 628. Also, at step 622, the first level fuzzy logic is applied to data points in the second mode categories 610R, 610Y, 610G to generate a second mode frequency detuning intermediate value 630.

At step 632, the first mode frequency detuning intermediate value 624 and the first mode frequency detuning intermediate value 628 may be fused to generate a first level first intermediate value 634. The first mode frequency detuning intermediate value 624 and the first mode frequency detuning intermediate value 628 may be fused using the second level fuzzy logic. Similarly, at step 636, the second mode frequency detuning intermediate value 626 and the second mode frequency detuning intermediate value 630 may be fused to generate a first level second intermediate value 638. The second mode frequency detuning intermediate value 626 and the second mode frequency detuning intermediate value 630 may be fused using the second level fuzzy logic. The second level fuzzy logic is explained in greater detail with reference to FIG. 7.

Additionally, at step 640, the first level first intermediate value 634 and the first level second intermediate value 638 may be fused to generate a second level first intermediate value 242. The first level first intermediate value 634 and the first level second intermediate value 638 may be fused using the second level fuzzy logic. In the presently contemplated configuration, the second level first intermediate value 242 is representative of the frequency detuning alarm 242 referred to in FIG. 2. For example, when the second level first intermediate value is equal to 40, then the frequency detuning alarm may be green. Similarly, if the third level first intermediate value is 80, then the frequency detuning alarm may be red.

FIG. 7 is an exemplary flow diagram that describes a second level fuzzy logic method 700, in accordance with an embodiment of the present method. In one embodiment, FIG. 7 explains the step 318 of FIG. 3 to generate the static deflections alarm 230 in greater detail. In another embodiment, FIG. 7 explains the steps 632, 636, 640 in FIG. 6 in greater detail. It may be noted that for ease of understanding FIG. 7 will be explained with two intermediate values as inputs to the fuzzy logic 700. However, the number of inputs or intermediate values to the fuzzy logic method 700 may vary as per requirement.

At step 702, a first intermediate value may be received. Similarly, at step 704, a second intermediate value may be received. The first intermediate value and the second intermediate value may be received from the data repository 28. At step 706, at least one strength of each of the first intermediate value 702 and the second intermediate value 704 may be determined. The strength of each of the first intermediate value 702 and the second intermediate value 704 may be determined by applying a membership function. The membership function, for example, may be a trapezoidal function, a triangular function, a Gaussian function, a sigmoidal function, and the like. For example, the membership function may be similar to the membership function described with reference to FIG. 5. The strength of the first intermediate value and the second intermediate value may be weak, average or strong. In certain embodiments, the strength may include a corresponding weight or a truth value of the strength. For example, the strength of the first intermediate value 312 may be average with a weight of 0.5. It may be noted that in certain embodiments, each of the first intermediate value and/or the second intermediate value may have multiple strengths. For example, the strength of the first intermediate value may be average and strong.

Furthermore, at step 708, fuzzy rules may be applied to the strengths of each of the first intermediate value and the second intermediate value. The fuzzy rules, for example are shown in Table 7.

TABLE 7

| First intermediate | Second intermediate | Alarm |
|---|---|---|
| value strength | value strength | category |
| Weak | Weak | Green |
| Average | Weak | Yellow |
| Strong | Weak | Yellow |

The application of the fuzzy rules to the strengths of each of the first intermediate value and the second intermediate value results in generation of at least one alarm category. At step 710, a fuzzy logic implication method is applied to the alarm categories utilizing an output membership function and an implication operator to generate at least one output value. The output membership function, for example, may be retrieved from the data repository 28. The implication operator, for example, may be a truncation operator, a minimum operator, a probabilistic operator, a maximum operator, or the like.

Furthermore, at step 712, a fuzzy logic aggregation method may be applied to the at least one output value to generate an aggregated function. The fuzzy logic aggregation method, for example, may be applied by using an aggregation operator. The aggregation operator, for example, may be an addition operator, a minimum operator, a maximum operator, or the like. Subsequently at step 714, the aggregated function may be defuzzified to generate a defuzzified value 716. The aggregated function, for example, may be defuzzified by determining a centroid, a bisector, and the like of the aggregated function. In one embodiment, the defuzzified value may be representative of the static deflection alarm 230. In another embodiment, the defuzzified value may be representative of the intermediate values 624, 626, 628, 630, 634, 638, (see FIG. 6). In certain embodiment, the defuzzified value may be representative of the frequency detuning alarm 242 (see FIG. 2, FIG. 6).

FIG. 8 is an exemplary flow diagram that describes a method 800 for generation of blade alarms generated by the blade alarm generator 204 in FIG. 2, in accordance with an embodiment of the present method. Particularly, the method 800 describes the steps 238, 240 to generate the blade alarms 242, 244, respectively referred to in FIG. 2 in greater detail. For ease of understanding, the method 800 will explain generation of the blade alarm 242 (see FIG. 2) corresponding to the blade B1. However, the method 800 may be used for generation of the blade alarm 244 (see FIG. 2) corresponding to the blade B(N) and blade alarms corresponding to other blades. The method 800 generates each blade alarm by fusing feature alarms corresponding to the blade by using a fuzzy inference method. As previously noted, the feature alarms may include a static deflection alarm, a dynamic deflection alarm, a frequency detuning alarm, a clearance alarm, and the like. However, for ease of understanding, the method 800 describes the generation of the blade alarm 242 corresponding to the blade B1 based upon the static deflection alarm 230 and the frequency detuning alarm 232 (see FIG. 2).

As previously noted with reference to FIG. 2, reference numeral 230 is representative of a static deflection alarm corresponding to the blade B1 and reference numeral 232 is representative of a frequency detuning alarm corresponding to the blade B1. At step 802, at least one strength of each feature alarm corresponding to the blade B1 may be determined. In the presently contemplated configuration, strength of the static deflection alarm 230 and the frequency detuning alarm 232 is determined.

As used herein, the term “strength of an alarm” is used herein to refer to confidence in the alarm. In one embodiment, the strength of an alarm may be weak, average or strong. The strength of the static deflection alarm 230 and the frequency detuning alarm 232 may be determined by using a membership function. The membership function, for example, may be a trapezoidal membership function, a triangular membership function, a Gaussian function, a sigmoidal function, and the like. The membership function, for example, may be retrieved from the data repository 28. For example, if the static deflection alarm 230 is a red alarm, then the strength of the green static deflection alarm may be determined as weak, average or strong using the membership function. The membership function, for example, may be similar to the membership function shown with reference to FIG. 5. It may be noted that in certain embodiments, multiple strengths of each of the static deflection alarms may be determined For example, the strength of the static deflection alarm may be average and strong. In certain embodiments, the strength of the static deflection alarm 230 and the frequency detuning alarm 232 may also include a truth value or a weight of the strength. For example, the strength of a static deflection alarm may be weak with a truth value of 0.5.

Furthermore, at step 804, fuzzy rules may be applied to the strengths of each of the feature alarms. In the presently contemplated configuration, fuzzy rules may be applied to the strengths of the static deflection alarm 230 and the frequency detuning alarm 232. The application of the fuzzy rules results in a determination of at least one blade alarm category. The fuzzy rules, for example may be retrieved from the data repository 28. Table 8 shows exemplary fuzzy rules.

TABLE 8

| Static deflection | Frequency detuning | Blade alarm |
|---|---|---|
| alarm strength 230 | alarm 232 | category |
| Weak | Weak | Green |
| Average | Weak | Yellow |
| Strong | Weak | Yellow |

At step 806, a fuzzy logic implication method is applied to the blade alarm categories that have been determined at step 804. The fuzzy logic implication method is applied using an output membership function and an implication operator. The output membership function, for example, may be retrieved from the data repository 28. The implication operator, for example, may be a truncation operator, a minimum operator, a probabilistic operator, a maximum operator, or the like. The application of the fuzzy logic implication method generates at least one output value. At step 808, a fuzzy logic aggregation method may be applied to the output values to generate an aggregated function. The fuzzy logic aggregation method may be applied by using an aggregation operator. The aggregation operator, for example, may be an addition operator, a minimum operator, a maximum operator, or the like. At step 810, the aggregated function may be defuzzified to generate a defuzzified value 242. The defuzzified value 242 is representative of the blade alarm 242 corresponding to the blade B1 determined at step 238 in FIG. 1.

Referring now to FIG. 9, a flowchart representing an exemplary method 900 for determining features of one or more blades, in accordance with an embodiment of the present techniques, is depicted. Particularly, FIG. 9 describes determination of static deflection and dynamic deflection. The one or more blades, for example, may be the one or more blades 12 (see FIG. 1). The method starts at step 902 where TOA signals corresponding to each of the one or more blades may be received by a processing subsystem, such as, the processing subsystem 24 (see FIG. 1). As previously noted with reference to FIG. 1, the TOA signals may be generated by a sensing device, such as, the sensing devices 16, 18 (see FIG. 1). In addition, the TOA signals, for example, may be the TOA signals 20, 22.

Furthermore, at step 904 actual TOA corresponding to each of the one or more blades is determined by the processing subsystem. The processing subsystem determines the actual TOA utilizing TOA signals corresponding to each of the one or more blades. More particularly, the processing subsystem determines one or more actual TOA corresponding to a blade utilizing a TOA signal corresponding to the blade. At step 906, a delta TOA corresponding to each of the one or more blades may be determined The delta TOA corresponding to a blade, for example, may be a difference of an actual TOA corresponding to the blade that is determined at step 904 and an expected TOA 905 corresponding to the blade. It may be noted that the delta TOA corresponding to the blade is representative of a variation from the expected TOA 905 of the blade at a time instant. The delta TOA, for example, may be determined using the following equation (1):

ΔTOAₖ(t)=TOA_{act(k)}(t)−TOAₑₓₚ₍ₖ₎ (1)

where ΔTOAₖ (t) is a delta TOA corresponding to a blade k at a time instant t or a variation from the expected TOA corresponding to the blade k at the time instant t, TOA_{act(k)} is an actual TOA corresponding to the blade k at the time instant t, and TOAₑₓₚ₍ₖ₎ is an expected TOA corresponding to the blade k.

As used herein, the term “expected TOA” may be used to refer to an actual TOA of a blade at a reference position when there are no defects or cracks in the blade and the blade is working in an operational state when effects of operational data on the actual TOA are minimal. In one embodiment, an expected TOA corresponding to a blade may be determined by equating an actual TOA corresponding to the blade to the expected TOA of the blade when a device that includes the blade has been recently commissioned or bought. Such a determination assumes that since the device has been recently commissioned or bought, all the blades are working in an ideal situation, the load conditions are optimal, and the vibrations in the blade are minimal. In another embodiment, the expected TOA may be determined by taking an average of actual times of arrival (TOAs) of all the blades in the device. The device, for example, may include axial compressors, land based gas turbines, jet engines, high speed ship engines, small scale power stations, or the like. It may be noted that the delta TOA is represented in units of time or degrees.

In one embodiment, at step 908, the units of the delta TOA corresponding to each of the one or more blades may be converted into measurement units such as mils. It should be understand that the measurement unit can be other units of metric or even on-metric units such as British/English units. In one embodiment, the delta TOA corresponding to each of the one or more blades that is in units of degrees may be converted in to units of mils using the following equation (2):

$$Δ {ToA}_{mils ( k )} ( t ) = \frac{2 π R \times Δ {ToA}_{Deg ( k )} ( t )}{360} \qquad ( 2 )$$

where ΔToAₘᵢₗₛ₍ₖ₎(t) is a delta TOA of a blade k at a t instant of time and the delta TOA is in units of mils, ΔToA_{Deg(k)}(t) is a delta TOA of the blade k at the t instant of time and the delta TOA is in units of degrees and, R is a radius measured from the center of the rotor to the tip of the blade k. The radius R is in units of mils In another embodiment, the delta TOA that is in units of seconds may be converted in to units of mils using the following equation (3):

$$Δ {ToA}_{mils ( k )} ( t ) = \frac{2 π R \times Δ {ToA}_{sec ( k )} ( t )}{60} \qquad ( 3 )$$

where ΔToAₘᵢₗₛ₍ₖ₎(t) is a delta TOA of a blade k at a t instant of time and the delta TOA is in units of mils, ΔToA_{sec(k)} (t) is a delta TOA of the blade k at the t instant of time and the delta TOA is in units of degrees and R is a radius of a blade from the center of a rotor of the blade. The radius R is in units of mils.

Moreover, at step 910, the static deflection of each of the one or more blades is determined based upon the delta TOA. The static deflection, for example may be determined by removing or deducting the effects of the one or more operational data and reseating of the blades on the actual TOA for the determination of the exact static deflection. In certain other embodiments, the static deflection, for example may be determined by normalizing the effects of the one or more operational data and reseating of the blades on the actual TOA for the determination of the static deflection. The operational data, for example, may include an inlet guide vane (IGV) angle, a load, speed, mass flow, discharge pressure, or the like. As used herein, the term “reseating of a blade” may be used to refer to a locking of a blade at a position different from the original or expected position of the blade in joints, such as, a dovetail joint.

Subsequently at step 912, the dynamic deflection corresponding to the one or more blades may be determined In one embodiment, a dynamic deflection corresponding to a blade may be determined by subtracting a static deflection corresponding to the blade from a delta TOA corresponding to the blade. In another embodiment, a dynamic deflection corresponding to a blade may be determined by subtracting a static deflection corresponding to the blade from a filtered delta TOA corresponding to the blade. The filtered delta TOA, for example, may be determined by filtering a delta TOA corresponding to the blade that is determined at step 906. The delta TOA may be filtered utilizing one or more techniques including average filtering, median filtering, or the like.

The embodiments of the present system and techniques result in real-time generation of alarms determination of features of one or more blades. The one or more features may be used to evaluate the health of the blades in real-time. Furthermore, the present system and techniques provides a central processing subsystem to determine the features of one or more blades in one or more devices, wherein the devices may be located at different remote locations. The normalized delta TOAs may be used for determining defects or cracks in the blades. Certain embodiments of the present techniques also facilitate detection of variations in the TOAs of the blade due to reseating of the blades. In addition, the determination of the normalized delta TOAs may be used for monitoring the health of the blades. For example, the normalized delta TOAs may be used to determine whether there are one or more cracks in the blades. The present system may continuously monitor health of turbomachinary blades located in geographically dispersed locations around the world 24×7. The present system has in-built redundancy to recover quickly after a hardware crash. The present system also provides visualization tools to analyze health of blades using features extracted from TOA data.

The embodiments of the present system and techniques disclose an automated anomaly detection framework for monitoring health of blades or devices including the blades. Certain embodiments of the present systems and techniques generate alarms representative of the health of the blades in real-time. These alarms alert plant operators about impending failures in blades or devices. Additionally, the present systems and techniques may monitor the health of the blades remotely. The present systems and techniques fuse multiple blade health features determined from times of arrival data collected by multiple sensors using fuzzy inference method. The present systems and techniques are robust to generate alarms even in the case of failure of one or more sensors. The present systems and techniques may generate alarms independent of human intervention.

Various embodiments described herein provide a tangible and non-transitory machine-readable medium or media having instructions recorded thereon for a processor or computer to operate a system for monitoring health of rotor blades, and perform an embodiment of a method described herein. The medium or media may be any type of CD-ROM, DVD, floppy disk, hard disk, optical disk, flash RAM drive, or other type of computer-readable medium or a combination thereof.

The various embodiments and/or components, for example, the monitor or display, or components and controllers therein, also may be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as a floppy disk drive, optical disk drive, and the like. The storage device may also be other similar means for loading computer programs or other instructions into the computer or processor.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments without departing from their scope. While the dimensions and types of materials described herein are intended to define the parameters of the various embodiments, they are by no means limiting and are merely exemplary. Many other embodiments will be apparent to those of skill in the art upon reviewing the above description. The scope of the various embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure. It is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method, comprising:
generating at least one feature alarm for a blade by fusing a plurality of features corresponding to the blade utilizing a fuzzy inference method, wherein the fuzzy inference method comprises:
generating a plurality of intermediate values by fusing one or more combinations of the plurality of features utilizing a fuzzy logic method; and
fusing the plurality of intermediate values utilizing a second level fuzzy logic method,
wherein the at least one feature alarm is representative of the health of the blade.

2. The method of claim 1, further comprising generating the plurality of features corresponding to the blade based upon times of arrival of the blade.

3. The method of claim 1, wherein generating the at least one feature alarm corresponding to the blade by fusing the plurality of features comprises fusing identical features corresponding to the blade.

4. The method of claim 1, wherein generating the at least one feature alarm corresponding to the blade comprises:
generating static deflection data corresponding to the blade based upon times of arrival data generated by a plurality of sensing devices; and
generating the at least one feature alarm by fusing the static deflection data using a static deflection fuzzy inference method,
wherein the at least one feature alarm is a static deflection alarm.

5. The method of claim 4, wherein the static deflection fuzzy inference method, comprises:
categorizing the static deflection data corresponding to the blade into multiple categories corresponding to each of the plurality of sensing devices;
generating intermediate values at multiple levels based upon the multiple categories corresponding to each of the plurality of sensing devices using a first level fuzzy logic; and
applying a second level fuzzy logic to the intermediate values to generate the static deflection alarm.

6. The method of claim 5, wherein the first level fuzzy logic comprises:
determining a percentage of static deflection data in each of the multiple categories in comparison to a number of data points in the static deflection data;
determining strength corresponding to each of the multiple categories utilizing the percentage of static deflection data and at least one membership function;
generating at least one intermediate category by applying fuzzy rules to the strength corresponding to each of the multiple categories;
generating at least one output value based upon an output membership function and the at least one intermediate category utilizing a fuzzy logic implication method; and
aggregating the at least one output value to generate the intermediate values.

7. The method of claim 1, wherein generating the at least one feature alarm corresponding to the blade comprises:
generating frequency detuning data corresponding to the blade based upon times of arrival data generated by a plurality of sensing devices; and
generating a frequency detuning alarm by fusing the frequency detuning data using a frequency detuning fuzzy inference method,
wherein the at least one feature alarm is a frequency detuning alarm.

8. The method of claim 7, wherein generating a frequency detuning alarm by fusing the frequency detuning data, comprises:
receiving frequency detuning data for at least one mode of vibration of a blade corresponding to each of the plurality of sensing devices;
categorizing the frequency detuning data for the at least one mode of vibration corresponding to each of the plurality of sensing devices into multiple categories corresponding to each of the at least one mode of vibration and the plurality of sensing devices;
applying a first level fuzzy logic to data points in each of the multiple categories corresponding to each of the at least one mode of vibration and the plurality of sensing devices to generate intermediate values; and
fusing the intermediate values at multiple levels using a second level fuzzy logic to generate the frequency detuning alarm.

9. The method of claim 1, further comprising generating a blade alarm corresponding to the blade by fusing respective feature alarms utilizing a fuzzy inference method.

10. The method of claim 9, further comprising:
generating a stage alarm corresponding to at least one stage of multiple blades in a device by selecting a blade alarm from a plurality of blade alarms corresponding to the multiple blades in the at least one stage; and
generating a device alarm corresponding to the device by selecting a stage alarm from the at least one stage alarm corresponding to the at least one stage.

11. A method, comprising:
generating a blade alarm for a blade by fusing a plurality of feature alarms corresponding to the blade utilizing a fuzzy inference method, wherein the fuzzy inference method comprises:
generating a plurality of intermediate values by fusing one or more combinations of the plurality of features utilizing a fuzzy logic method; and
iteratively fusing the plurality of intermediate values utilizing a second level fuzzy logic method,
wherein the feature alarms comprise a static deflection alarm and a frequency detuning alarm.

12. The method of claim 11, wherein generating a blade alarm corresponding to the blade by fusing a plurality of feature alarms, comprises:
determining at least one strength of each of the feature alarms corresponding to the blade;
determining at least one blade alarm category by applying fuzzy rules to the at least one strength of each of the feature alarms corresponding to the blade;
generating at least one output value by applying a fuzzy logic implication method to the at least one blade alarm category; and
generating an aggregated function by aggregating the at least one output value; and
generating the blade alarm by defuzzifying the aggregated function.

13. A system, comprising:
a processing subsystem comprising an alarm generation module that generates at least one feature alarm for a blade by fusing a plurality of features corresponding to the blade utilizing a fuzzy inference method, wherein the fuzzy inference method comprises:
generating a plurality of intermediate values by fusing one or more combinations of the plurality of features utilizing a fuzzy logic method; and
iteratively fusing the plurality of intermediate values utilizing a second level fuzzy logic method,
wherein the at least one feature alarm is representative of the health of the blade.

14. The system of claim 13, wherein plurality of features comprise static deflection, dynamic deflection, clearance and frequency detuning.

15. The system of claim 14, wherein the processing subsystem further generates the plurality of features corresponding to the blade based upon times of arrival of the blade.

16. The system of claim 13, further comprising a plurality of sensing devices to generate signals that are representative of the times of arrival of the blade.

17. The system of claim 13, wherein the at least one feature alarm is a static deflection alarm, a dynamic deflection alarm, a frequency detuning alarm, a clearance alarm, and combination thereof.

18. The system of claim 17, further comprising a display device that displays the at least one alarm.

19. A system, comprising an alarm generation module, wherein the alarm generation module comprises:
a feature alarm generator that generates a plurality of feature alarms corresponding to a plurality of blades by fusing a plurality of features corresponding to the plurality of blades utilizing a fuzzy inference method, wherein the fuzzy inference method comprises:
generating a plurality of intermediate values by fusing one or more combinations of the plurality of features utilizing a fuzzy logic method; and
fusing one or more combinations of the plurality of intermediate values utilizing a second level fuzzy logic method; and
a blade alarm generator that generates a plurality of blade alarms corresponding to the plurality of blades by fusing the plurality of blade alarms utilizing a fuzzy inference method,
wherein the at least one feature alarm is representative of the health of the blade.

20. The system of claim 19, wherein the one or more combinations of the plurality of features comprises identical features, features determined based upon times of arrival generated by same sensing device and features of same categories, features of different categories, or combinations thereof.

21. The system of claim 19, wherein the one or more combinations of the plurality of intermediate values comprises intermediate values generated by fusing data points in a single category, intermediate values generated by fusing data points in a similar category, intermediate values generated by fusing intermediate values generated by fusing intermediate values of different categories, intermediate values generated by fusing randomly selected intermediate values, or combinations thereof.

22. The system of claim 19, further comprising:
a stage alarm generator that generates at least one stage alarm corresponding to a stage of multiple blades in a device by selecting a blade alarm from multiple blade alarms corresponding to the multiple blades; and
a unit alarm generator that generates a unit alarm corresponding to the system by selecting a stage alarm from the at least one stage alarm.

23. The system of claim 19, wherein the system is a compressor, a turbine engine, a turbine and an axial compressor.

24. A turbine engine system, comprising
a plurality of sensing devices to generate signals representative of times of arrival corresponding to a plurality of blades;
a processing subsystem that generates a plurality of features based upon the times of arrival corresponding to the plurality of blades;
a processing subsystem comprising an alarm generation module that:
fuses the plurality of features at multiple levels utilizing a fuzzy inference method to generate at least one alarm,
wherein the at least one alarm is representative of the health of the plurality of blades.

25. A non-transitory computer readable medium for a blade health monitoring system encoded with a program to instruct one or more processors to:
fuse a plurality of features for a plurality of blades at multiple levels utilizing a fuzzy inference method to generate at least one alarm,
wherein the at least one alarm is representative of the health of the plurality of blades.
